(19) United States
(12) Patent Application Publication
(10) Pub. No.: US 2026/0260302 A1
(43) Pub. Date: Sep. 3, 2026

(54) DISTRIBUTED DEMAND SIDE VIRTUAL PRIVATE UTILITY

(71) Applicant: Budderfly, Inc., Shelton, CT (US)

(72) Inventors: Albert Subbloie, Orange, CT (US); Thomas Flynn, Glastonbury, CT (US); Paul Schmidt, Rocky Hill, CT (US); Kenneth Buda, Scarsdale, NY (US); Christopher J. DeBenedictis, Branford, CT (US); Jaan Leemet, Aventura, FL (US); Sarah Elizabeth Crouchet, Manchaca, TX (US); Kevin Edgar Morgan, Guilford, CT (US); Luis Ocasio, Wethersfield, CT (US); Mark James Williams, San Ramon, CA (US)

(21) Appl. No.: 19/555,866

(22) Filed: Mar. 3, 2026

Related U.S. Application Data
(60) Provisional application No. 63/766,090, filed on Mar. 3, 2025.

(51) Int. Cl. G06Q 50/06

(52) U.S. Cl. CPC G06Q 50/06

(57) ABSTRACT

The disclosed system, device and method provides for coordinated control of both supply and demand of/for electrical energy behind the utility meter within a grid. Several facilities each include network devices, one or more supply devices and one or more energy use devices positioned electrically behind a meter for each facility, which meter is used by the utility to measure and bill for usage of the energy supply. The network devices have the ability to measure use of the energy use devices, as well as control their use and the network devices also have the ability to measure the supply capacity and control the supply of energy to the grid from those supply devices. A computer has software executing thereon which modifies/controls use and supply of electrical energy devices based on available supply at the facilities, usage at the facilities and the availability to make adjustments to supply and demand across the several facilities.

### FIELD OF THE INVENTION

The present disclosure relates to systems and methods of managing energy generation and supply from the point of use and in particular the creation of a virtual private utility whereby supply of energy and demand controls may be used to balance grids locally and supply and generate energy locally. Namely, the present disclosure involves management and control of energy supply at the points/locations where energy is used on the user side of the meter as well as control of demand for energy at those locations.

### BACKGROUND OF THE INVENTION

The traditional utility model involves typically one large company with one or a few locations which generate or supply energy. For example, these may be comprised of large-scale coal, natural gas, wind, solar and other generation sites which are designed to generate electricity on a large scale for a large number of homes. The utility then manages distribution of that power through various sub stations and sub sets or local grids. There may be larger grids which have sub grids within them which are managed by the same regional utility. As part of this management, the decision on when to turn on/off generation capacity can be complex and is often based on forecasting, which can be wrong. In some cases, on demand generation of energy is more expensive because the process involves starts and stops and acceleration/deceleration and the associated increase in energy input into those changes resulting in higher prices for electricity generated in this manner. The more on demand electric supply often comes from “peaker” plants which are made available on short notice when peaks in demand outstrip the normal generation capacity. Additionally, some plants will be run at an excess to account for fluctuations in demand, but when running at an excess, the varying amount of overgeneration is often run through a shunt or other power dissipation device. Such a device allows for quick fluctuations in grounding or wasting that excess energy such that the grid can maintain a relatively stable voltage and operation.

Several of the inventors have separately theorized and created a system that manages demand on a more flexible basis to allow for use of power which would otherwise be shunted to ground and wasted as shown in U.S. 11,824,351, the contents of which are incorporated by reference herein. However, solving for demand fluctuations may not provide a complete solution in that the ability to modify demand does not solve for the increasing use of solar, wind and other localized forms of generation or solve for the increasing use of on-site storage, all of which is “behind” the meter from the perspective of the utility (i.e. the meter on which the utility charges is between the generation and distribution done by the utility and the use and generation/supply at the facility.

### SUMMARY OF THE INVENTION

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

It is an object of the invention to provide for control and distribution of energy which is generated and/or supplied from behind the meter of a number of facilities and to offset that generation/supply based on demand from other facilities.

Other objects include the ability to control energy supply in real time based on real time energy use and needs of a number of facilities.

It is a further object of the invention to enable the generation and supply capacity of several facilities to act like a virtual utility within a subset of a power grid, supplying energy to the grid to offset use of other facilities that are also controlled.

It is a further object of the invention to provide for third party control of supply from the demand side of the energy grid which third party also provides for control of energy usage despite not using such energy but being responsible/liable to pay the utility for the usage of the first parties.

Another object of the invention is to enable smart distributed on demand storage to reduce the need to shunt or dissipate large electrical loads to keep a stable supply available.

It is a further object of the to combine these mentioned distributed supply control and management features with demand management to increase the overall efficacy of the management protocol.

These and other objects are achieved by providing for several first party facilities each including network devices, one or more supply devices, and one or more energy use devices positioned electrically behind a meter for each facility, which meter is used by the utility (which may be considered the second party) to measure and bill for usage of the energy supply. The network devices have the ability to measure use of the energy use devices, as well as control their use and the network devices also have the ability to measure the supply capacity and control the supply of energy to the grid from those supply devices. A computer has software executing thereon which is controlled by the third party and allows the third party to modify supply of energy from the supply devices to the grid based on usage data from several of the facilities. The supply devices may generate and/or store energy, for example solar generation and battery storage (and combinations) are but some example of supply devices. The software can also modify demand for energy, particularly in a coordinated way with the supply controls.

In one aspect a system is provided for enabling control of local energy supply devices and local energy demand devices at first party locations to distribute energy in one or more power grids. The system includes a computer having software executing thereon, said software in communication with a plurality of network devices at a plurality of facilities which plurality of facilities are located geographically apart. Each facility has a set of the plurality of network devices including at least one network device, and one or more of a group of energy devices consisting of at least one energy supply device and a plurality of energy use devices. At least one of the plurality of facilities includes one or more of the at least one energy supply device and at least a second one of the plurality of facilities comprising at least one of the plurality of energy use devices. Two or more of the facilities are associated with different first parties, wherein each facility has a meter positioned electrically between energy supplied external to the corresponding facility and the plurality of network devices. The meter is positioned electrically between the energy supplied and the energy devices. The software is configured to control the energy devices via the plurality of network devices and said software further configured to receive energy supply data and energy use data, the energy supply data indicative of available energy supply capacity at one or more of the plurality of facilities and the energy use data indicative of energy usage at one or more of the plurality of facilities. The software is configured to determine one or more target instantaneous power load adjustments (TIPLA) associated with the plurality of facilities based on the energy usage data and the energy supply data as determined from the plurality of network devices. The software is further configured to generate and send control signals comprising supply control signals and demand control signals, the control signals sent to one or more of the plurality of network devices to distribute the TIPLA across the plurality of facilities by the supply control signals adjusting energy supplied by the plurality of energy supply devices and the demand control signals adjusting energy demand of the plurality of energy use devices at different ones of the plurality of facilities.

In certain aspects the one or more of the plurality of facilities is associated with different first parties and the software is managed by a third party and a second party obtains meter readings from the meters to charge the third party for usage of electricity by the first entities. In other aspects, each first party is responsible to pay the third party for usage of energy by the energy use devices. In other aspects each of the plurality of network devices is located at one of a plurality of facilities and comprises multiple network devices associated with at least one of the energy supply or energy use devices at the respective one of the plurality of facilities. In yet other aspects the software is further configured to send control signals to two or more of the network devices located at different facilities to reduce energy usage based on the TIPLA and actual usage of two or more of the energy use devices located at different facilities and the software is further configured to send control signals to two or more of the network devices located at additional different facilities to increase energy supply available from energy supply devices at those additional different facilities.

In still other aspects the control signals are determined by the software based on one or more rates for use of the energy supply of the utility. In still other aspects the software is further configured to send control signals to two or more of the network devices located at different facilities to increase energy usage based on the TIPLA and actual usage of two or more of the energy use devices located at different facilities. In yet other aspects the control signals to increase energy usage are sent to one or more energy storage devices located at the different facilities. In still other aspects the software is configured to receive target instantaneous power usage (TIPU) data from a utility associated with supply of the energy supplied and based on a rate for energy usage associated with the utility the software determines the control signals to control supply of energy from the plurality of energy supply devices. In still other aspects the at least one energy supply device at a first facility of the plurality of facilities is selected from a group consisting of battery, solar, wind generator and combinations thereof and the energy supply device at a second facility of the plurality of facilities includes a combustion powered generator.

In other aspects the supply control signals and the demand control signals are sent simultaneously or nearly simultaneously to different facilities, for example groups of signals may be sent together or in rapid succession or sequentially for different facilities in a coordinated manner to control both supply and demand in real time or near real time. In yet other aspects said software further monitors impact of the supply control signals and demand control signals on the one or more power grids and said software continuously and in real time adjusts the supply control signals and demand control signals based on changes within the grid of: demand for electricity, availability of adjustments to demand for electricity and supply of electricity.

Yet other objects are achieved by providing a method for controlling delivery of stored electrical power within one or more power grids of one or more utilities which supplies an energy supply including one or more steps of: providing software executing on a computer which is in communication with a plurality of network devices, a plurality of energy supply devices and a plurality of energy use devices, each of the plurality of network devices located at one of a plurality of facilities which plurality of facilities are located geographically apart and two or more of the facilities are associated with different first parties, wherein each facility has a meter positioned electrically between energy supplied by the utility and the plurality of network devices, energy supply devices and energy use devices, at least some of the plurality of network devices configured to control one or more of the energy supply and/or energy use devices and at least some of the plurality of network devices configured to provide usage data of the energy usage device to said software; receiving from plurality of network devices usage data associated with a set of the plurality of energy use devices located at the one of the plurality of facilities; determining with said software one or more target instantaneous power load adjustments (TIPLA) associated with the plurality of facilities based on the energy usage data and energy supply data indicative of available energy supply at one or more of the plurality of facilities; controlling with said software a set of the plurality of energy supply devices and energy use devices at different facilities by generating and sending control signals comprising supply control signals and demand control signals, the control signals sent to one or more of the plurality of network devices to distribute the TIPLA across the plurality of facilities by the supply control signals adjusting energy supplied by the plurality of energy supply devices and the demand control signals adjusting energy demand of the plurality of energy use devices at different ones of the plurality of facilities. In certain aspects the third party is responsible to pay the one or more utilities an amount for a total usage of the energy supply by the first parties delivered by the one or more utilities to the first parties during a time period based on readings of the meters.

In other aspects each first party is responsible to pay the third party for usage of energy by the energy use devices. In still other aspects the third party is credited for energy supplied by the energy supply devices during the time period. In yet other aspects the control signals are determined by the software based on one or more rates for use of the energy supply of the utility.

In still other aspects wherein the energy use data and the energy supply data includes forecasted energy use data and forecasted energy use data, the forecasted energy use data indicative of anticipated energy usage in the future and the forecasted energy supply data is indicative of anticipated energy supply available in the future. In still other aspects the software is configured to receive target instantaneous power usage (TIPU) data from the utility and based on a rate for energy usage associated with the utility the software determines the control signals to control supply of energy from the plurality of energy supply devices. In still other aspects the at least one energy supply device at a first facility of the plurality of facilities is selected from a group consisting of battery, solar, wind generator and combinations thereof and the energy supply device at a second facility of the plurality of facilities includes a combustion powered generator.

In yet other aspects the software further monitors impact of the supply control signals and demand control signals on the one or more power grids and said software continuously and in real time adjusts the supply control signals and demand control signals based on changes within the grid of: demand for electricity, availability of adjustments to demand for electricity and supply of electricity.

Other objects of the invention and its particular features and advantages will become more apparent from consideration of the following drawings, claims and accompanying detailed description. It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions or combinations of functions described herein.

### DESCRIPTION OF THE DRAWINGS

FIG. 1 shows an exemplary facility arrangement according to the present invention.

FIG. 2 shows the arrangement of several of the facilities according to FIG. 1 within the system of the present invention.

FIG. 3 is a functional flow diagram showing implementation of controls of FIGS. 1-2.

FIG. 4 is a functional flow diagram showing further implementation of the system of FIGS. 1-2.

FIG. 5 a functional flow diagram showing further implementation of the system of FIGS. 1-2.

FIG. 6 is a functional flow diagram showing further implementation of the system of FIGS. 1-2.

FIG. 7 is an exemplary process flow diagram showing functionality of the software used in implementing of FIGS. 1-6.

### DETAILED DESCRIPTION OF THE INVENTION

Reference will now be made in detail to specific embodiments illustrated in the accompanying drawings. In the following detailed description, numerous specific details are set forth to provide a thorough understanding. However, it will be apparent to one of ordinary skill in the art that embodiments may be practiced without these specific details. In other instances, known methods, procedures and/or components have not been described in detail so as not to unnecessarily obscure aspects of the embodiments.

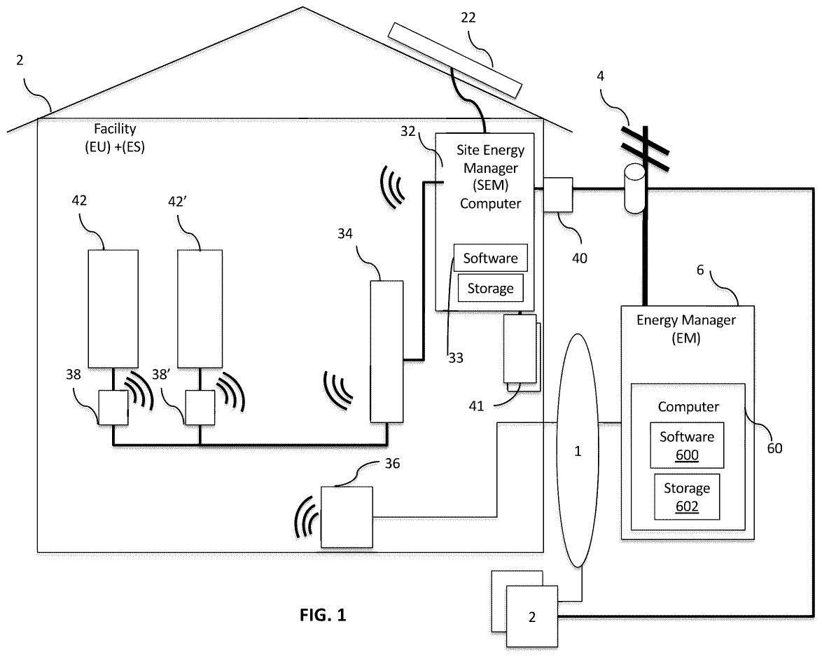

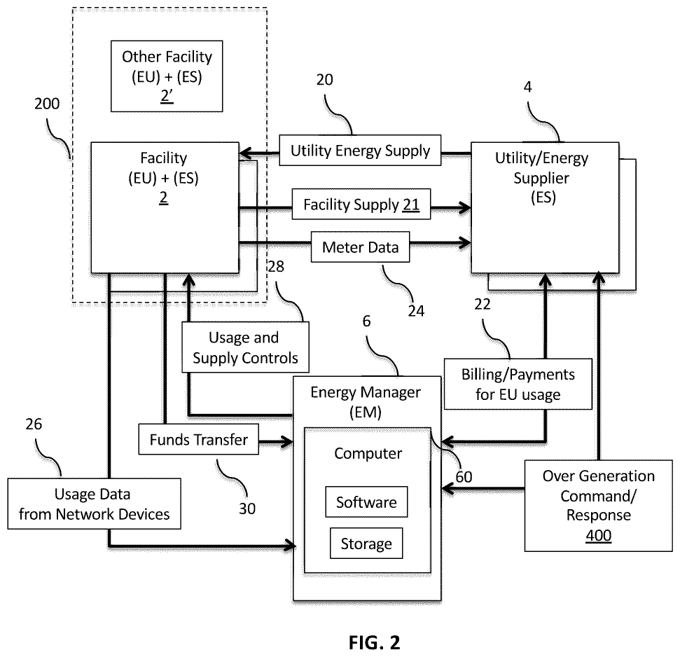

Referring to FIG. 1, several facilities 2 are shown, one in greater detail. Referring to the facility 2 shown in greater detail, a site energy manager computer 32 is provided as a network device which communicates with facility router 36. This controller 32 connects electrically to local generation systems such as solar array 22, a battery 38, the incoming utility 4 supply at meter 40 and the circuit panel 34. Site energy manager computer 32 and its software 33 enables control of control how various forms of energy are used/distributed on the facility 2 level and the energy manger 6 and its computer 60 and its software 600 enable control of how various forms of energy are used/distributed across multiple facilities. In some cases the energy manger 6 and its computer 60 via software 600 directly determines control instructions at individual facility levels based on various data inputs from the facility and other sources described herein. In other cases, the site energy manger 32 determines controls for its individual facility with those commands and the data being shared with the energy manger computer 60 so that the energy manger computer 60 can override some or all of those controls if needed. The devices at the facility generally fall into energy use (EU) and energy supply (ES) devices, with refrigerators, HVAC, lighting and the like being energy use devices and solar panels, batteries, combustion generators, wind turbines etc being example of energy supply devices. However, some energy supply devices (e.g. batteries) can both use and supply energy, depending if they are charging or discharging. Some facilities may have a combination of ES and EU devices, others may only have one or the other (e.g. EU or ES). However, the overall grid 200 (FIG. 2), will in general have a mixture of devices which allows for the coordination of these devices and how and when they are used.

Various sensors 41 (wired/wireless) are also provided at the facility 2 to read environmental conditions. Thus, controller 32 manages the site-specific requirements of the energy management program using local information such as the data from sensors such as temperature, humidity, occupancy and more. Further, information about historical energy usage and billing data such as tariffs and peak energy periods are factored into the local decision making about whether or not to charge or discharge batteries and when to use the energy supply from the grid. Any portion of this data may also come via the energy manger computer 60 or other sources described herein. Energy manager 6 takes a more holistic view across sites and is aware of the needs of all the sites under its control. While the site-specific energy manager computer 32 can make its own decisions as to use of the energy storage devices on its own site, the energy manager 6 oversees this programming and can override the decisions for more efficient and/or effective control and operation of the facilities when considered in aggregate. It is understood that each facility 2 may include one or more of the features of the facility shown in detail. The controller is shown with a wireless connection to the central controller 36, but it is understood that any form of network or data connection/link may be used. Several devices 42/42′, 34, 32, 36 within the facility 2 are shown with wireless capabilities, but it is equally understood that wired or other network connections known to those skilled in the art may be employed. The meter 40 may also include a network connection and wireless capabilities. The meter 40 is used by the utility 4 to charge for usage by the facilities 2. Each facility is connected to the utility electricity supply. In some cases, the meter 40 provides for the ability to determine both energy use by the facility and energy supplied by the facility to the grid. In particular, while some meters allow for energy supplied to the grid to in effect cause the meter to count backwards, it is preferable that knowledge of both what was used and what was supplied and when is available to the Energy Manager 6. Notably, at particular times, the ability for to supply energy from one facility to meet peak demands may not be sufficient to warrant a preferred reimbursement rate, but the ability to provide energy in larger quantities drawn from several facilities at once may enable the energy manager 6 to obtain a more favorable peak energy supply rate. The ability to have control over both supply behind the meter and have control over demand and modify both may provide further benefits to stabilizing the grid. For example, it may not be possible to modify the demand cycle for compressors of refrigeration units (or HVAC units) due to local needs to run both at the same time behind one meter, but it may be possible at a different facility to delay turning on one or more compressors and thus overall reduce energy load. At the same time, such a demand reduction may still be insufficient and thus the release of stored supply to the grid may be warranted with the release from one facility that ordinarily would not release supply. Thus, by coordinated action in terms of demand and supply controls, the target adjustment of load can be achieved and these targets and resulting controls can be calculated and determined instantaneously and in real or near real time and monitored continuously.

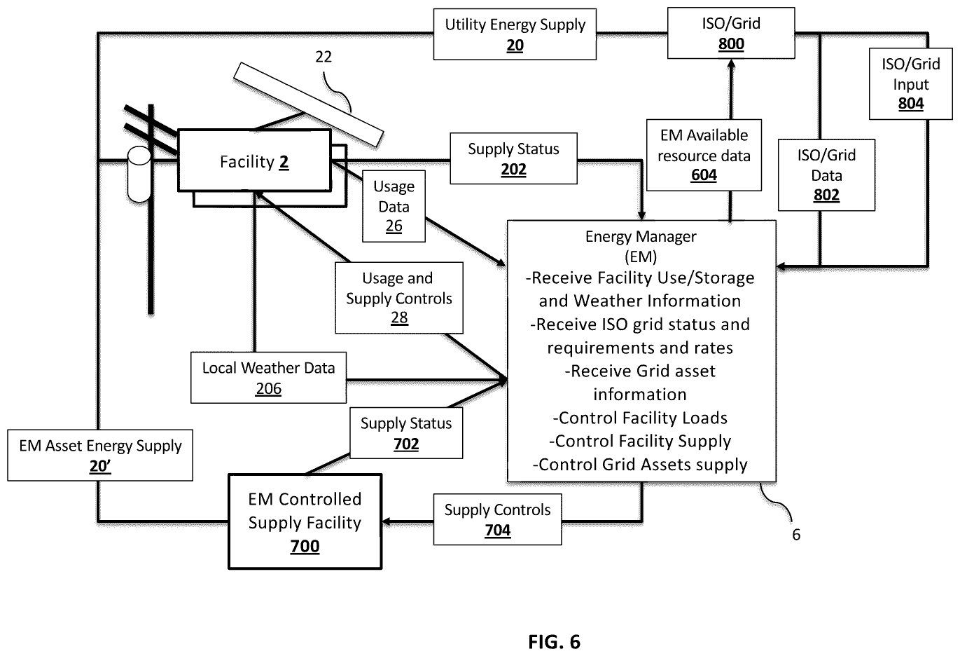

As further shown in FIG. 6, the energy manger 6 may have control of energy supply assets both behind the meter and on the grid, for example a combination of local building solar arrays and a larger solar farm and control over both is contemplated.

The router 36 is in communication with the energy manager 6 and its computer with software executing thereon and in wireless or wired communication with the site energy manger 32 and the various other devices 32/34/42/42′/38/38′. The software provides for monitoring use by the energy use devices 42/42′ and further provides for control of the generation/storage devices 22/38/32. The energy use devices 42/42′ may be a variety of different devices such as coolers, air conditioners/HVAC, freezers, ice machines, drink machines, lights, ovens, cooking devices and the like. Some of these energy use devices 42/42′ may have the networked control and monitoring devices 38/38′ built in whereas others may require the control and monitoring devices 38/38′ to be added. These network devices enable monitoring and/or control of the energy use devices and the energy storage/generation devices. The circuit panel 34 may also provide a level of control and monitoring, the control will be less granular as it will be on a circuit by circuit level, but there may be instances where such control is appropriate in some cases. The circuit panel 34 may also be provide with monitoring functions as well. The various control and/or monitoring functions of the devices disclosed herein enables the energy manager 6 to control both use and generation and further respond to use demands with generation. Importantly though, the facility by facility and often device by device capabilities for monitoring and control enable the energy manager 6 to have greater flexibility in energy use and generation than with a single facility. Namely, since one facility may have larger demands that cannot be curtailed, control over one facility alone may not provide adequate response options. If the need to reduce usage from the utility 4 still exists across the grid or subsection thereof, other facilities under the control of the energy manger 6 may provide for greater flexibility, allowing the energy manager 6 to meet the reduced demand needs from the utility 4 while also meeting the use needs across several of its facilities.

It should be noted that while the additional facilities 2 of FIG. 1 are shown connected to the same utility pole, this depiction is representative only in that the various facilities may be all connected to a particular subsection of the power grid, e.g. within a certain area from a common sub-station or which is capable of being supplied by two or more of the same sub stations. Furthermore, in the event of a failure of the utility 4 at a localized level, the several generation/storage 22/38 devices distributed throughout the grid may enable supply of energy locally without the need for the utility to supply any power. This would enable the energy manager 6 to effectively operate as its own utility by aggregating the demand and generation/storage needs/capacity of several facilities and having access to control most or all of the foregoing. Further, some sites may be better suited for installation of storage and generation devices than others and thus where it may not be ordinarily warranted for one facility to have significantly more generation capacity than needed, the ability to control the supply of that facility would allow for the excess supply to be distributed throughout the grid where ordinarily the incentive to have such supply available would not exist.

Since the energy manger 6 through the various devices and controls described herein has the ability to supply the utility 4 with power on demand from several facilities and also has real time visibility into real time use from several facilities, the energy manager 6 has the ability to supply energy from one facility with an excess to meet the demands from another facility. The energy manager can therefore determine a target for both usage and supply based on facility needs and supply capacity. The targeted instantaneous power load adjustments may be determined as the basis for what targeted changes to the power load are needed. Once the overall adjustment is determined, the individual controls can be determined from available data on current usage, anticipated usage, weather patterns and historical information along with supply availability, generation expected. The targeted instantaneous power supply (TIPS) may be determined as the basis for control of the various supply devices across several facilities, with the energy manager drawing power from several different supply devices located on the demand supply of the meter of several different facilities, thus allowing for the TIPS to be met across several different facilities. If the TIPS is too high of a need for supply given the expected generation/supply capacity both current and anticipated in the future, the energy manager software may also reduce usage from several different locations in order to reduce the TIPS requirements by modifying demand—e.g. receiving or determining a target instantaneous power usage (TIPU). Particularly, when the TIPS exceeds the supply capacity of the various facilities within the sub grid 200, the TIPU may be adjusted and thus demand reduced to meet the supply constraints. The rates of supply from the utility 4 may further be used to adjust the TIPS requirements from behind the meter in that if the utility rate is favorable, it may be preferable to use energy from the utility. Further, when the utility needs the facilities to use energy for storage, e.g. charging batteries, the TIPU may be increased accordingly based on rates, thus increasing demand by charging the battery or other storage device. The TIPLA generally looks holistically at the needs of the grid so that the TIPU and TIPS can be determined and be determined for different facilities.

Some energy managers 60/32 may include algorithms that forecast energy use for a particular site using historical data, machine learning algorithms, and environmental data. These systems may anticipate (and even reserve) some energy from the storage devices (38 batteries) at times. Some energy managers also have access to rate data and can anticipate lower market rates for charging storage devices 38 when prices are low. While the goal of the virtual power plant (VPP) is to also allow the supply of the stored energy 38 to supplement the grid power at times of need, the availability of stored energy may fluctuate based on the existing algorithms in the energy managers. As compensation models vary, so may the availability of said energy storage. Given that current models offer wholesale rates for stored energy and only at certain times, there are often greater benefits to simply using this energy to offset peak demand or offset high cost energy windows.

It is conceived that the grid can also anticipate needs and provide curtailment windows to a given facility 2. It is also conceived that the utility may place a greater value on such energy than the simple wholesale rates and may be able to become more creative in how the availability of this stored energy is compensated, such inputs in terms of various rates and thresholds for changes of rates based on scale can be part of the information available to the energy manager 60/32 from which various control validations/instructions/overrides are implemented. Models such as offsetting peak usage in other areas of the grid can be compelling and is enabled by the ability to manage and deliver energy at appropriate times. Further, the ability to control demand for energy can provide for further benefits. In cases where the energy supply exceeds the current demand of the facility, the storage device(s) 38 can be used to both supply local energy needs as well as provide additional power to the grid thus further offsetting demand on the overall grid, including to other facilities 2′ within the grid 200 which are not controlled by the energy manger as is further detailed in FIG. 2.

Referring to FIG. 2, the various facilities 2 may be grouped into grid subsets 200. In this case, the facility uses energy and also supplies energy. This facility supply 21 may be considered to supply the utility 4, but in practice, one facility may be supporting the utility 4 to supply energy to the local grid 200 (e.g. grid sub-set) by discharging a battery or solar energy or other supply device to the grid. This supply may also be partial in that the facility may generate more than it uses and thus be able both meet its usage needs while also add to the supply for the grid. By sharing the excess supply of several facilities, insufficient supply from other facilities may be compensated for. As a result, the utility 2 does not need to generate as much and preferably does not need to generate anything. The energy manager 6 acts to control the usage and supply 28 of the various facilities 2. These controls are computed by the energy manger software on its computer 60. The usage data from the various network devices 26 is provided to this software from several different facilities 2 and thus enables the usage and supply controls 28 to be determined. The responsible party for the facility 2 is responsible to pay 30 the energy manager 6 based on usage. Typically the energy manger 6 will have supplied various upgrades to the facility 2, these can include the network devices, the supply and use devices that the energy manager controls, including the entire device or components thereof. This may be in the form of upgraded HVAC, refrigerators, cooktops, ovens, lighting, solar, battery and other various devices along with associated controllers that allow the energy manager to both obtain the data 26 and then to implement the controls 28. The utility 4 will bill 22 the energy manager 6 or usage by the facility 2. Here though, the utility bill will be reduced based on the energy supply 21 provided by the facility to the grid 200 or the utility. As a result, the funds transfer 30 from the facility responsible party to the energy manager 6 will reflect the energy used by the facility 2, which may include energy generated on site at the facility by the supply devices (e.g. solar) that are installed by or at the direction of the energy manager 6. In the ideal scenario, the utility bill 22 and the required payments from the energy manager to the utility will be minimal. In some cases, all generation will be provided at the facility level and the utility may then charge for distribution. Stated differently, the subset or sub grid 200 composed of facilities controlled by the energy manger 6 may net out to no usage as far as the utility meter data 24 is concerned. At the same time, the utility may charge for distribution as there may be other facilities within the grid which are not controlled by the energy manger 6. In some cases, the total supply by the facilities 2 may be sufficient to also meet the demand/needs of the non-controlled facilities, or other facilities 2′ which are also part of the sub grid 200. In this manner, the generation/supply of energy may take place entirely on the demand or use side of the meter 40 across the various facilities 2 in the sub grid 200, sufficient to supply all facilities 2/2′ via the utility supply lines. Therefore, in preferred practice, the utility supply 20 of energy is from other facilities and generated from the user side of the meter, which differs from the traditional utility model with comparably much fewer supply/generation facilities (power plants) in comparison to the number of facilities who use energy. For example, in the traditional model, each grid may have 3-4 supply facilities that supply energy for 1000 times as many facilities (e.g. 3000-4000 user facilities for the 3-4 supply facilities/power plants). By enabling real time control of supply and demand, there can be many more supply facilities compared to use facilities. For example, 1-10 supply facilities behind the meter for every 100 or fewer use facilities.

In the alternative, the sub grid 200 may be composed only of facilities under the control of the energy manger 6, and thus sufficient capacity of supply and reserve may be distributed throughout this sub grid 200 of controlled facilities 2 to allow for a safety factor and the possibility of under generation at certain locations.

The distribution of supply may also be effective at allowing to smooth out the generation capacity of the utility. When there is excess generated capacity from the utility, the storage devices at the facility 2 may draw power from the grid to store it locally at reduced rates, thus allowing the utility to charge for energy it would otherwise ground through an impedance/resistor and waste. As a result, the energy manger may communicate with the utility with commands/responses 400 whereby the utility requests that the energy manager draw power from the grid 20 which results in appropriate commands 28 to cause the various storage devices (e.g. batteries) at the different facilities to charge. The energy manager may confirm such actions 400. The request by the utility may simply be in the form of data sent to the energy manager where the computer and its software determines the excess capacity that should be stored in the facility storage devices that are on the demand side of the meter 40. In some cases, a the energy supplier (ES) 4 or utility may require that distributed storage capacity among several batteries be used to absorb fluctuations in grid loads. The utility 4 may offer a discounted rate to the energy manager (EM) 6 for absorbing these fluctuations via several facilities 2 absorbing such loads which would otherwise be shunted or dissipated to ground. One of the challenges with batteries is that they may not allow for sufficient ability to absorb energy needed by the utility in that the charge rate may not be enough to account for what the utility 4 needs to balance loads. But, several batteries/storages distributed throughout several facilities 2 may allow the utility greater flexibility in requesting absorption of energy locally for storage such that the facility 2 stores excess energy that the utility can provide at a favorable rate. The ability of the energy manager 6 to control several facilities in both demand from energy use devices such as refrigerators, HVAC, lighting and other such devices and in supply capacity increases through e.g. batteries which looks like demand to the utility 4 can allow the energy manager 6 to provide greater flexibility to the utility.

While current utility algorithms allow for the resale or excess energy at wholesale rates from a given facility, this in itself is not compelling for many facilities. It is anticipated that with a large number of available energy sources, the utility can benefit greatly from the availability of this excess energy in near real time and the ability to store excess energy in a distributed manner among multiple facilities. It is also anticipated that additional compensation models may be explored by both the utility and the source of large amounts of distributed stored energy.

For example, in the case of an entity that manages and has control over the storage, charging and discharging of such storage devices in a given grid sector, the ability to access such sources of energy as either an energy supply or a large offset to energy use can offset the need to build expensive peaker plants in a given area. Thus, the energy manager having control a large number of distributed energy storage devices in strategic locations within the grid and across multiple grids or sub grids which may provide for greater scale to benefit from in terms of overall energy savings and in terms of efficiency of supply and distribution of power within the grid, providing a more stable and reliable supply of energy.

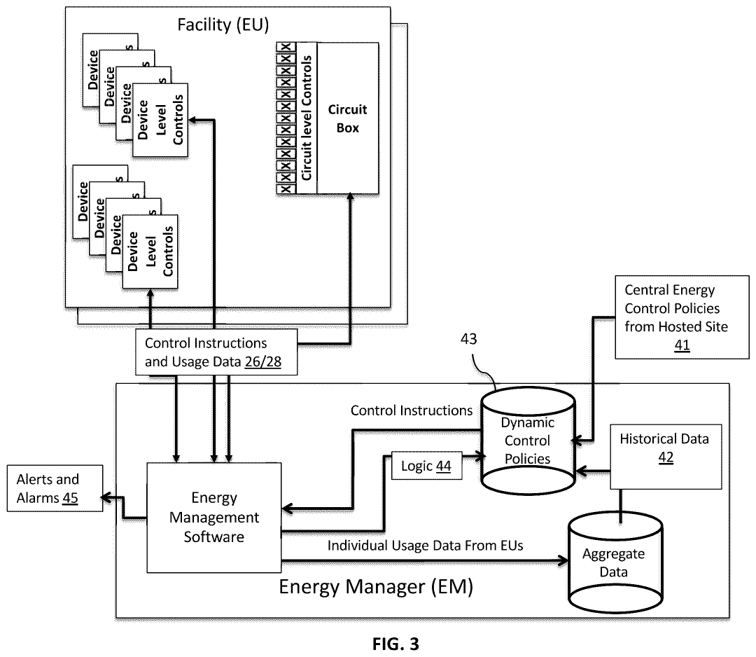

Further detail at the facility and energy manager level is shown in FIG. 3. Here the energy management software of the energy manger computer 60 can send control instructions to the various devices at the device level and/or circuit level as well as receive usage data, which usage data can include supply and supply capacity information, for example, the amount of stored energy, generation capacity or available storage to receive energy. The energy management software may generate alerts/alarms 45 in the event of any anomaly. The energy manager also receives data from the energy using facilities which is aggregated and stored and combined with historical data 42 to allow the energy management software to apply its logic 44 to the various control policies 43, which policies may also be dynamic based on the data provided from the various facilities. The energy manager may receive energy control policies 41 that are applied to several facilities (or all facilities) as well.

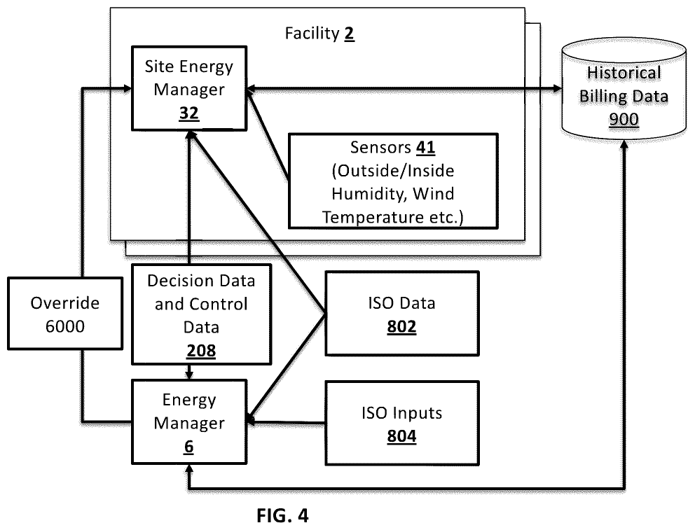

Referring now to FIG. 4, further detail is provided on the interaction between the site energy manger 32 and the energy manger 6 (and its computer etc). Here, the site energy manager has access to historical billing data 900 (which may also indicate use) along with access to various sensors 41. Independent System Operators (ISO) grew out of Federal Energy Regulatory Commission Orders Nos. 888/889 where the Commission suggested the concept of an Independent System Operator as one way for existing tight power pools to satisfy the requirement of providing non-discriminatory access to transmission. Subsequently, in Order No. 2000, the Commission encouraged the voluntary formation of Regional Transmission Organizations (RTO) to administer the transmission grid on a regional basis throughout North America. While an “ISO” data feed is described, it is understood that the ISO data may be direct from the RTO or a combination of RTO and ISO data or ISO data, thus the use of “ISO” is for brevity and may refer to the ISO, the RTO, other grid operators and combinations thereof. An ISO data 802 feed is also provided whereby the site energy manger 32 can receive grid status, generation capacity, rate information for various time periods, as well as rate forecasts, as examples. From some or all of the foregoing data (which may be called decision data), the site energy manger 32 and its associated software is able to compute various controls for the supply and demand resources and their associated network devices which control the same. The decision data (the data used to determine the controls) and control data (e.g. the actual to be implemented controls) are sent to the energy manger 6. The energy manger 6 receives this data from multiple facilities located geographically apart from each other. The ISO data 802 feed is also accessible to the energy manger 6 and ISO inputs 804 may also be received at the energy manger 6. In this manner, if the ISO/grid is experiencing or expects to experience a peak demand event where local storage and/or demand curtailment can be beneficial to grid stability, this can be indicated to the energy manger 6 via the inputs 804. The energy manger uses the combination of some or all of the foregoing data to validate the controls for the site energy mangers 32 as indicated by the control data. In certain cases, an override 6000 may be issued to one or more of the energy mangers 32 which overrides the locally computed commands. This will usually be a scenario where based on data and status of several facilities, the control for a particular facility should be modified for a more efficient control scheme. The override 6000 may be in the form of modification of a specific command, adding a command or potentially modifying the algorithm or weights for various inputs in the energy manger 32 and its software 33.

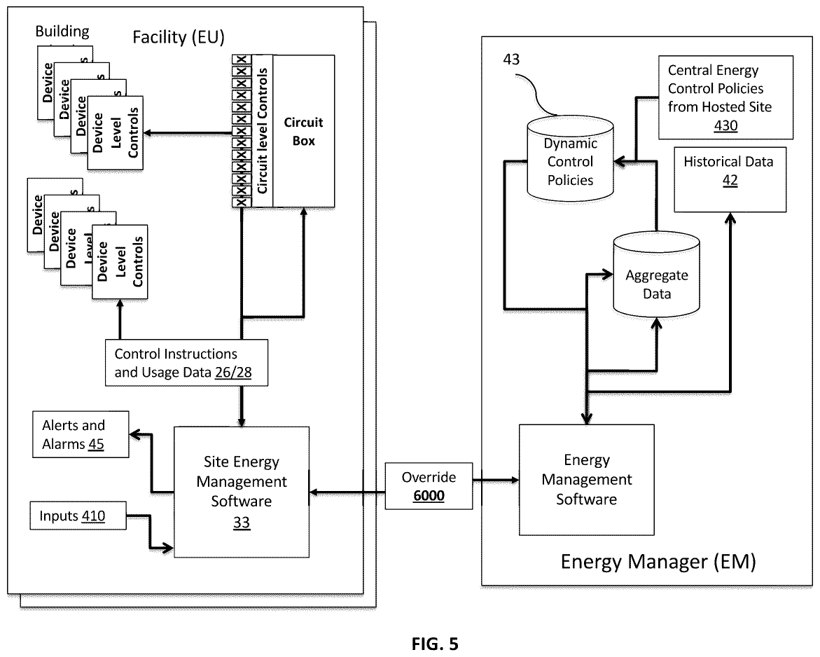

Referring to FIG. 5, further detail on the interplay between the facility and the energy manger is shown. The site energy management software can receive usage data and can send control instructions to the various devices directly or may implement circuit level controls or combinations thereof. Various alerts and alarms 45 may be generated when there is anomalous activity occurring. These alerts/alarms may be locally noticed and may also be sent to the energy manger. The site energy management software 33 receives various inputs 410 including sensor data 41, ISO data 802 and ISO inputs 804 as described/shown in FIG. 4 in order to determine its control inputs 28. The energy manger may override 6000 one or more of these controls 28, which override can include canceling, modifying, supplementing with additional controls or combinations thereof. The energy management software has access to aggregated data concerning past controls, sensor inputs and the cost results and historical data 42. Various dynamic control policies 43 may be stored and also may be provided from external computers or through logging into the energy manger computer.

As shown in FIG. 6 the role of the energy manager is to provide holistic control of both use and generation/supply of electricity among several facilities 2. Therefore, the energy manager and its computer/software (shown in other figures) will receive use and storage information about several facilities along with local weather information from various sensors at the facility and/or local weather stations. This includes the main meter consumption data, load factors and aggregated gross loads for the facility. Further data about the facilities includes the capacity and availability of energy behind the meter, for example renewables such as wind/solar and battery storage available both for supply and to charge. Load control information and related settings and usage is also provided from the facilities 2 to the energy manager. Next, the energy manager can receive ISO/grid data/information including wholesale power costs with both day ahead and real time pricing, forward capacity market rates, forecast data, weather data and system load statistics. The energy manger will further receive ISO grid status, requirements and rates. Additional information provided to the energy manger is supply resources which are controlled by the energy manger, for example large battery banks, solar farms, wind farms and other storage and generation facilities that the energy manger controls. With this information the energy manger and its computer/software can generate commands to control loads/supply at facilities 2 as well as grid assets controlled by the energy manger. Therefore, as shown in FIG. 6, the energy manger receives ISO/Grid data 802 and may also receive inputs from the ISO/Grid 804 in the form of requests or needs to balance the grid loads. Supply status 202 from the facilities can indicate how much solar 22 and battery energy is available for use or how much capacity (e.g. battery) is available for storage. The facility 2 will have various energy using devices such as refrigerators, freezers, HVAC using energy and this information is provided to the energy manger in the form of usage data 26. Local weather data 206 is further provided including temperature, wind, sun, humidity and various other weather condition sensors known to those of skill in the art. The supply status 702 of the energy manger controlled facility 700 may be further provided and then supply controls 704 for that facility 700 provided by the energy manger. As a result of the availability of all this data along with the ability to implement controls on the storage/supply and use side, the energy manager can indicate available resources 604 to the ISO/Grid 800 and its associated computer such that the ISO/Grid inputs 804 may be adjusted accordingly.

The energy manager (EM) 6 differs from traditional utility arrangements or peak demand technology in that the energy manger 6 has the ability to control both demand and supply of energy at locations that the energy manger does not actually use the energy. For example, the facilities 2 may be a collection of quick serve restaurants (e.g. Subway, McDonalds, Burger King etc) as well as office buildings, retail stores and a variety of different businesses which use energy and are operated/owned by many different entities, in some cases competitors, who use energy. The energy use profiles across the facilities may very in vastly different ways. The energy manger 6 has the ability to provide both visibility into usage in a granular way to the various devices (e. g refrigerators, HVAC, coolers, heating, lighting, etc.) at each of the facilities along with supply visibility (e.g. batteries, solar, geothermal, wind etc.) and then in addition to such visibility the energy manager 6 has control over those devices. These facilities have different needs and different demands for energy at different times and thus the energy manager is able to understand and react to those needs. The energy manager will however be responsible or liable for the usage of the facilities 2 in that the energy manager generates a bill to the facility 2 that is based on then current utility rates for that facility if purchased directly from the utility or may be an alternative rate structure that the energy manger determines. The energy manager 2 may also determine a monthly baseline usage for each facility 2 based on historical usage and the various devices at the facility that consume energy, this historical usage may be discounted a percentage or other amount and adjusted for weather such that the facility is charged this discounted usage rate (which may vary from month to month or may be a flat rate) multiplied by the utility per usage charge (e.g. the generation and supply charges). Any fees from the utility or that may be required to be paid can be added, and the energy manager may then further reduce energy usage through a variety of efficiency upgrades and may in the net/overall view as to the supply of energy have sufficient supply among all the facilities to net out to zero or close to zero usage from the utility in terms of generated/supplied energy. There still may be delivery charges that are passed on to the energy manger from the utility. However, the energy manager is now able to both reduce usage and obtain the benefit of the margin in reduction to enable equipment upgrades and is also able to reduce the energy manager's effective rate paid to the utility by providing supply response and demand response, and potentially sufficient supply to cover all demand under the control of the energy manger. The foregoing allows the energy manger incentives reduce wasted energy in a manner that a single facility with control and supply would not be able to accomplish.

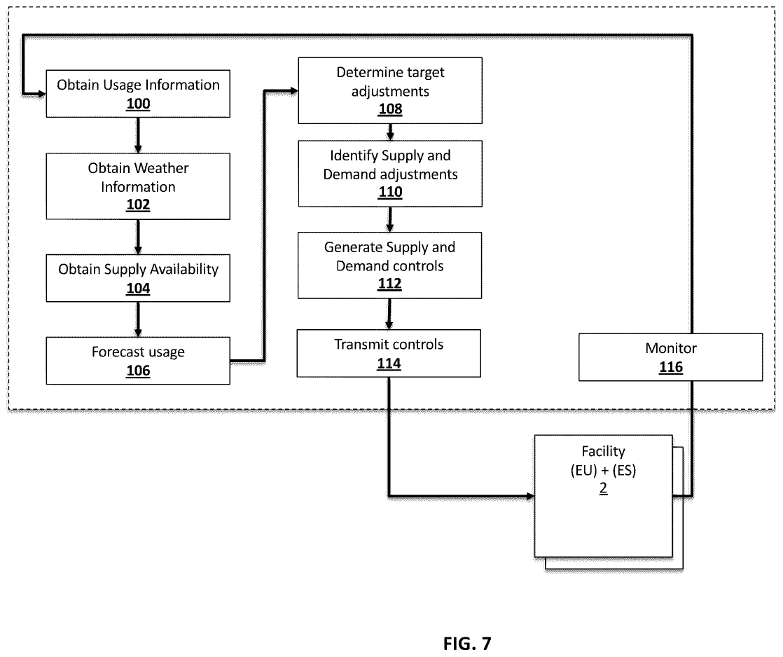

FIG. 7 shows a process flow of the software 33 implemented by the energy manger. The usage information is obtained 100, along with weather information 102 and supply availability 104. Usage is forecast 106 and target adjustments are determined 108, typically on an instantaneous or real or near real time basis. With the TIPLA determined, the supply and demand adjustments can be determined 110, and these will be determined on a facility by facility basis in order to, in aggregate, respond to the TIPLA needs. The supply and demand controls are generated 112 and transmitted 114 to the various facilities 2. The software monitors 116 the impact in real time and the feedback loop continues to monitor and adjust demand and supply in real time.

There are no limitations in terms of the particular embodiments described in this application, which are intended as illustrations of various aspects only. Many modifications and variations can be made without departing from its spirit and scope, as will be apparent to those skilled in the art. Functionally equivalent methods and apparatuses, in addition to those enumerated herein, will be apparent to those skilled in the art from the foregoing descriptions. Such modifications and variations are intended to fall within the scope of the appended claims. Only the terms of the appended claims are intended to be limiting, along with the full scope of equivalents to which such claims are entitled. It is also to be understood that the terminology used herein, e.g., “and”, “or”, “including”, “at least” as well as the use of plural or singular forms, etc., is for the purpose of describing examples of embodiments and is not intended to be limiting. It is further understood that all communication between the various entities 2, 4, 6 may be done electronically and handled by the various computers/software associated with each entity and their location(s).

What is claimed is:

1. A system for enabling control of local energy supply devices and local energy demand devices at first party locations to distribute energy in one or more power grids, the system comprising:
a computer having software executing thereon, said software in communication with a plurality of network devices at a plurality of facilities which plurality of facilities are located geographically apart;
each facility comprising a set of the plurality of network devices including at least one network device, and one or more of a group of energy devices consisting of at least one energy supply device and a plurality of energy use devices;
at least one of the plurality of facilities comprises one or more of the at least one energy supply device and at least a second one of the plurality of facilities comprising at least one of the plurality of energy use devices;
two or more of the plurality of facilities are associated with different first parties, wherein each facility has a meter positioned electrically between energy supplied external to the corresponding facility and the plurality of network devices
wherein the meter is positioned electrically between the energy supplied and the energy devices;
said software configured to control the energy devices via the plurality of network devices and said software further configured to receive energy supply data and energy use data, the energy supply data indicative of available energy supply capacity at one or more of the plurality of facilities and the energy use data indicative of energy usage at one or more of the plurality of facilities;
said software is configured to determine one or more target instantaneous power load adjustments (TIPLA) associated with the plurality of facilities based on the energy usage data and the energy supply data as determined from the plurality of network devices;
said software further configured to generate and send control signals comprising supply control signals and demand control signals, the control signals sent to one or more of the plurality of network devices to distribute the TIPLA across the plurality of facilities by the supply control signals adjusting energy supplied by the plurality of energy supply devices and the demand control signals adjusting energy demand of the plurality of energy use devices at different ones of the plurality of facilities.

2. The system of claim 1 wherein one or more of the plurality of facilities is associated with different first parties and the software is managed by a third party and a second party obtains meter readings from the meters to charge the third party for usage of electricity by the first entities.

3. The system of claim 2 wherein each first party is responsible to pay the third party for usage of energy by the energy use devices.

4. The system of claim 1 wherein each of the plurality of network devices is located at one of a plurality of facilities and comprises multiple network devices associated with at least one of the energy supply or energy use devices at the respective one of the plurality of facilities.

5. The system of claim 1 wherein the software is further configured to send control signals to two or more of the network devices located at different facilities to reduce energy usage based on the TIPLA and actual usage of two or more of the energy use devices located at different facilities and the software is further configured to send control signals to two or more of the network devices located at additional different facilities to increase energy supply available from energy supply devices at those additional different facilities.

6. The system of claim 5 wherein the control signals are determined by the software based on one or more rates for use of the energy supply of the utility.

7. The system of claim 1 wherein the software is further configured to send control signals to two or more of the network devices located at different facilities to increase energy usage based on the TIPLA and actual usage of two or more of the energy use devices located at different facilities.

8. The system of claim 7 wherein the control signals to increase energy usage are sent to one or more energy storage devices located at the different facilities.

9. The system of claim 12 wherein the software is configured to receive target instantaneous power usage (TIPU) data from a utility associated with supply of the energy supplied and based on a rate for energy usage associated with the utility the software determines the control signals to control supply of energy from the plurality of energy supply devices.

10. The system of claim 1 wherein the at least one energy supply device at a first facility of the plurality of facilities is selected from a group consisting of battery, solar, wind generator and combinations thereof and the energy supply device at a second facility of the plurality of facilities includes a combustion powered generator.

11. The system of claim 1 wherein the supply control signals and the demand control signals are sent simultaneously or nearly simultaneously to different facilities.

12. The system of claim 1 wherein said software further monitors impact of the supply control signals and demand control signals on the one or more power grids and said software continuously and in real time adjusts the supply control signals and demand control signals based on changes within the grid of: demand for electricity, availability of adjustments to demand for electricity and supply of electricity.

13. A method for controlling delivery of stored electrical power within one or more power grids of one or more utilities which supplies an energy supply comprising:
providing software executing on a computer which is in communication with a plurality of network devices, a plurality of energy supply devices and a plurality of energy use devices, each of the plurality of network devices located at one of a plurality of facilities which plurality of facilities are located geographically apart and two or more of the facilities are associated with different first parties, wherein each facility has a meter positioned electrically between energy supplied by the utility and the plurality of network devices, energy supply devices and energy use devices, at least some of the plurality of network devices configured to control one or more of the energy supply and/or energy use devices and at least some of the plurality of network devices configured to provide usage data of the energy usage device to said software;
receiving from plurality of network devices usage data associated with a set of the plurality of energy use devices located at the one of the plurality of facilities;
determining with said software one or more target instantaneous power load adjustments (TIPLA) associated with the plurality of facilities based on the energy usage data and energy supply data indicative of available energy supply at one or more of the plurality of facilities;
controlling with said software a set of the plurality of energy supply devices and energy use devices at different facilities by generating and sending control signals comprising supply control signals and demand control signals, the control signals sent to one or more of the plurality of network devices to distribute the TIPLA across the plurality of facilities by the supply control signals adjusting energy supplied by the plurality of energy supply devices and the demand control signals adjusting energy demand of the plurality of energy use devices at different ones of the plurality of facilities
wherein the third party is responsible to pay the one or more utilities an amount for a total usage of the energy supply by the first parties delivered by the one or more utilities to the first parties during a time period based on readings of the meters.

14. The method of claim 13 wherein each first party is responsible to pay the third party for usage of energy by the energy use devices.

15. The method of claim 13 wherein the third party is credited for energy supplied by the energy supply devices during the time period.

16. The method of claim 13 wherein the control signals are determined by the software based on one or more rates for use of the energy supply of the utility.

17. The method of claim 13 wherein the energy use data and the energy supply data includes forecasted energy use data and forecasted energy use data, the forecasted energy use data indicative of anticipated energy usage in the future and the forecased energy supply data is indicative of anticipated energy supply available in the future.

18. The method of claim 13 wherein the software is configured to receive target instantaneous power usage (TIPU) data from the utility and based on a rate for energy usage associated with the utility the software determines the control signals to control supply of energy from the plurality of energy supply devices.

19. The method of claim 13 wherein the at least one energy supply device at a first facility of the plurality of facilities is selected from a group consisting of battery, solar, wind generator and combinations thereof and the energy supply device at a second facility of the plurality of facilities includes a combustion powered generator.

20. The method of claim 13 wherein said software further monitors impact of the supply control signals and demand control signals on the one or more power grids and said software continuously and in real time adjusts the supply control signals and demand control signals based on changes within the grid of: demand for electricity, availability of adjustments to demand for electricity and supply of electricity.
